(19) United States
(12) Patent Application Publication
(10) Pub. No.: US 2026/0135470 A1
(43) Pub. Date: May 14, 2026

(54) SEMICONDUCTOR DEVICE

(71) Applicant: FUJI ELECTRIC CO., LTD., Kawasaki-shi (JP)

(72) Inventor: Kei MINAGAWA, Matsumoto-city (JP)

(73) Assignee: FUJI ELECTRIC CO., LTD., Kawasaki-shi (JP)

(21) Appl. No.: 19/319,406

(22) Filed: Sep. 4, 2025

(30) Foreign Application Priority Data
Nov. 12, 2024 (JP) 2024-197367

(51) Int. Cl. H02M 1/32; H02M 3/158

(52) U.S. Cl. CPC H02M 1/32; H02M 3/158

(57) ABSTRACT

The present disclosure is intended to provide a semiconductor device that suppresses unintended activation of the reduction protection of control power supply voltage during the initial charging period and enables the reduction protection of control power supply voltage during the stable period of the control power supply voltage. A semiconductor device includes an IGBT, a first control IC, a second control IC, and a bootstrap circuit configured to generate a control power supply voltage VccU supplied to the control IC by bootstrap operation using a control power supply voltage supplied to the second control IC. The second control IC has a control voltage detection circuit configured to detect a reduction in the control power supply voltage, and the control voltage detection circuit has a period detection circuit configured to detect an initial charging period in which the bootstrap circuit 3 is initially charged by the bootstrap operation.

### CROSS REFERENCE TO RELATED APPLICATIONS AND INCORPORATION BY REFERENCE

This application claims benefit of priority under 35 U.S.C. § 119 based on Japanese Patent Application No. 2024-197367 filed on Nov. 12, 2024, the entire contents of which are incorporated by reference herein.

### TECHNICAL FIELD

The present invention relates to a semiconductor device.

### BACKGROUND ART

An intelligent power module (IPM) that integrates an insulated gate bipolar transistor (IGBT) for power conversion, a free wheeling diode (FWD), and an integrated circuit (IC) for drive and protection functions into a single package has been known. An IPM used as a three-phase inverter circuit for driving an electric motor such as a three-phase motor requires, for example, four control voltages (three for the upper arm and one for the lower arm), but when a bootstrap circuit including a bootstrap diode (BSD), a capacitor, and a limiting resistor is used, the power supply of the upper arm may be replaced with a capacitor. This reduces the component mounting area of a power conversion device including an IPM.

For a bootstrap circuit, before an IGBT is used to start driving a loading device such as a motor, the capacitor is needed to be charged by switching operation of the IGBT of the lower arm (initial charging). During the initial charging, current (inrush current) flows from the control power supply for the lower arm to the bootstrap circuit. If the inrush current is an unexpectedly large current, the capacity of the control power supply for the lower arm is insufficient, and power supply reduction protection may be activated in the lower arm. To suppress this power supply reduction protection, the bootstrap circuit has the limiting resistor as described above.

PTL 1 discloses an electric power conversion device capable of detecting an abnormal state of switching of an initial charging circuit while preventing an excessive inrush current from flowing through a capacitor due to abnormal switching of the initial charging circuit.

PTL 2 discloses an invention for reducing inrush current, on the basis of the magnitude of current generated due to an earlier termination of initial charging, by determining the subsequent termination timing of initial charging when a plurality of capacitors are initially charged in a power converter.

### CITATION LIST

### Patent Literature

PTL 1: JP 2022-040631 A
PTL 2: JP 2023-162789 A

### SUMMARY OF INVENTION

### Technical Problem

In conventional reduction protection of control power supply voltage, an operation voltage level is designed for protection against a voltage reduction on the basis of a stabilized control power supply voltage. Hence, during operation with large voltage fluctuations, such as during the initial charging period, the reduction protection of control power supply voltage is easily activated. If power supply reduction protection is activated in the lower arm, the capacitor in a bootstrap circuit is not charged, and the control power supply voltage of the upper arm fails to reach an intended voltage level, unfortunately. Meanwhile, if the activation voltage of the reduction protection of control power supply voltage is set according to voltage fluctuations during the initial charging period, protection operation may be insufficiently activated when the control power supply voltage is stabilized at an intended voltage level, unfortunately.

The present disclosure is intended to provide a semiconductor device that suppresses unintended activation of the reduction protection of control power supply voltage during the initial charging period and enables the reduction protection of control power supply voltage during the stable period of the control power supply voltage.

### Solution to Problem

A semiconductor device according to an aspect of the disclosure includes a first switching element, a second switching element connected in series with the first switching element and provided on a lower potential side than the first switching element, a first control circuit configured to control drive operation of the first switching element, a second control circuit configured to control drive operation of the second switching element, protection operation of the first switching element, and protection operation of the second switching element, and a bootstrap circuit configured to generate a first control power supply voltage supplied to the first control circuit by bootstrap operation using a second control power supply voltage supplied to the second control circuit. In the semiconductor device, the second control circuit has a voltage reduction detection circuit configured to detect a reduction in the second control power supply voltage, and the voltage reduction detection circuit has a period detection circuit configured to detect an initial charging period in which the bootstrap circuit is initially charged by the bootstrap operation.

### Advantageous Effects of Invention

According to an aspect of the present disclosure, unintended activation of the reduction protection of control power supply voltage is suppressed during the initial charging period, and the reduction protection of control power supply voltage is enabled during the stable period of the control power supply voltage.

### BRIEF DESCRIPTION OF DRAWINGS

FIG. 1 is a block diagram schematically illustrating an example structure of a semiconductor device according to a first embodiment of the present disclosure;

FIG. 2 is a block diagram schematically illustrating an example structure of a control IC for a lower arm included in the semiconductor device according to the first embodiment of the present disclosure;

FIG. 3 is a block diagram schematically illustrating an example structure of a control voltage reduction detection circuit included in the control IC for the lower arm of the semiconductor device according to the first embodiment of the present disclosure;

FIG. 4 is a view schematically illustrating example waveforms of charging current flowing through a bootstrap circuit included in the semiconductor device according to the first embodiment of the present disclosure and control power supply voltages for an upper arm and for a lower arm;

FIG. 5 is a view schematically illustrating example waveforms of charging current flowing through a bootstrap circuit included in a conventional semiconductor device and control power supply voltages for an upper arm and for a lower arm;

FIG. 6 is a block diagram schematically illustrating an example structure of a control voltage reduction detection circuit included in a control IC for the lower arm of a semiconductor device according to an alternative embodiment of the first embodiment of the present disclosure;

FIG. 7 is a block diagram schematically illustrating an example structure of a control voltage reduction detection circuit included in a control IC for the lower arm of a semiconductor device according to a second embodiment of the present disclosure;

FIG. 8 is a block diagram schematically illustrating an example structure of a voltage reduction detection circuit included in a control IC for the lower arm of a semiconductor device according to an alternative embodiment of the second embodiment of the present disclosure;

FIG. 9 is a block diagram schematically illustrating an example structure of a voltage reduction detection circuit included in a control IC for the lower arm of a semiconductor device according to a third embodiment of the present disclosure;

FIG. 10 is a block diagram schematically illustrating an example structure of a voltage reduction detection circuit included in a control IC for the lower arm of a semiconductor device according to a fourth embodiment of the present disclosure; and

FIG. 11 is a block diagram schematically illustrating an example structure of a voltage reduction detection circuit included in a control IC for the lower arm of a semiconductor device according to a fifth embodiment of the present disclosure.

### DESCRIPTION OF EMBODIMENTS

Embodiments for carrying out the present disclosure will be described with reference to drawings. In each drawing, the dimensions or scale of each component may differ from the actual ones. The embodiments described below are illustrative embodiments expected when the present disclosure is carried out. The scope of the present disclosure is not limited to the following illustrative embodiments.

### First Embodiment

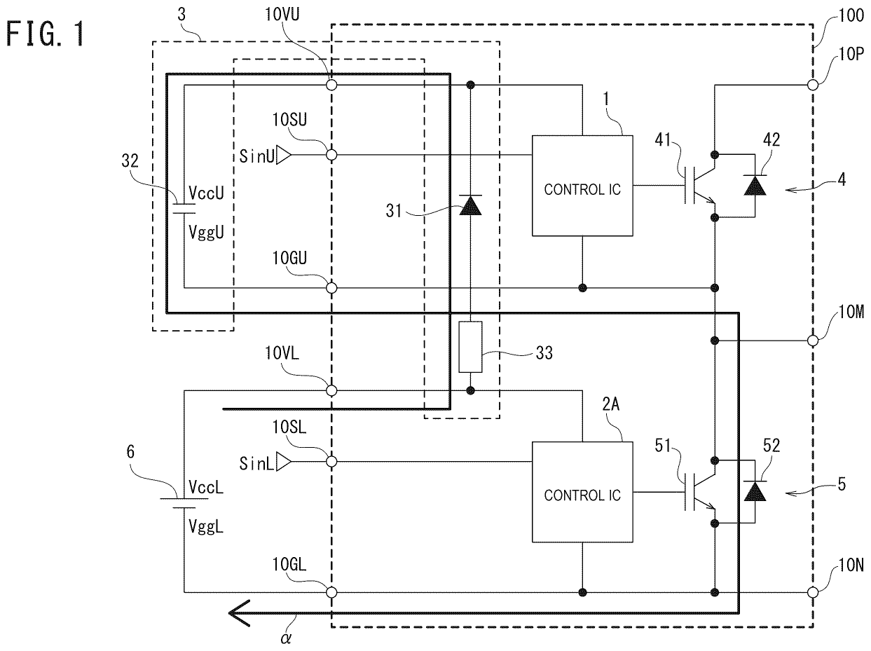

A semiconductor device according to the first embodiment of the present disclosure will be described by using FIG. 1 to FIG. 5. The semiconductor device according to the present embodiment will be described by using an intelligent power module as an example, and the semiconductor device according to the present embodiment is applicable to a device having a function to generate a voltage on the high potential side by using a voltage on the low potential side, such as a bootstrap operation.

### 1-1. Entire Structure of Semiconductor Device:

The entire structure of a semiconductor device 100 according to the present embodiment will be described by using FIG. 1. FIG. 1 is a block diagram schematically illustrating an example structure of the semiconductor device 100.

As illustrated in FIG. 1, the semiconductor device 100 includes a control IC 1 for the upper arm, a control IC 2A for the lower arm, a bootstrap circuit 3, a drive element 4 for the upper arm, and a drive element 5 for the lower arm. The semiconductor device 100 includes a positive electrode side voltage input terminal 10P, a negative electrode side voltage input terminal 10N, an intermediate terminal 10M, a control power supply voltage input terminal 10VU for the upper arm, a reference potential terminal 10GU for the upper arm, and a control signal input terminal 10SU for the upper arm. The semiconductor device 100 includes a control power supply voltage input terminal 10VL for the lower arm, a reference potential terminal 10GL for the lower arm, and a control signal input terminal 10SL for the lower arm. Hereinafter, a “control power supply voltage input terminal” may be abbreviated to a “power supply input terminal”.

The control IC 1 for the upper arm (an example of the first control circuit) is a HVIC (high voltage IC) that is on the high potential side or controls the drive element 4 for the upper arm. The control IC 1 is an integrated circuit that controls drive operation of an IGBT 41 (an example of the first switching element) on the basis of an input signal SinU for the upper arm input through the control signal input terminal 10SU. The input signal SinU is input from a controller (not illustrated) that controls the semiconductor device 100. The control IC 1 operates using, as the reference potential, a reference potential VggU for the upper arm impressed to the reference potential terminal 10GU and, as the power supply, a control power supply voltage VccU for the upper arm (an example of the first control power supply voltage) generated by bootstrap operation (specifically described later) of the bootstrap circuit 3.

The control IC 2A for the lower arm (an example of the second control circuit) is a LVIC (low voltage IC) that is on the low potential side or controls the drive element 5 for the lower arm. The control IC 2A is an integrated circuit that controls drive operation of an IGBT 51 (an example of the second switching element) on the basis of an input signal SinL for the lower arm input through the control signal input terminal 10SL and controls protection operation of the IGBT 41 and the IGBT 51. The input signal SinL is input from a controller (not illustrated) that controls the semiconductor device 100. The control IC 2A operates using, as the reference potential, a reference potential VggL for the lower arm impressed to the reference potential terminal 10GL and, as the power supply, a control power supply voltage VccL for the lower arm (an example of the second control power supply voltage) supplied through the power supply input terminal 10VL for the lower arm.

The control power supply voltage VccL is generated by a voltage generation circuit 6 connected to the power supply input terminal 10VL and the reference potential terminal 10GL. The voltage generation circuit 6 is constituted by, for example, a DC power supply. The positive electrode side of the voltage generation circuit 6 is connected to the power supply input terminal 10VL, and the negative electrode side of the voltage generation circuit 6 is connected, for example, to a reference potential terminal (for example, a ground terminal) of the semiconductor device 100 and to the reference potential terminal 10GL. Accordingly, the reference potential terminal 10GL is connected to the ground terminal of the semiconductor device 100.

The drive element 4 has the IGBT 41 and a free wheeling diode 42. The gate of the IGBT 41 is connected to the output terminal of the control IC 1, the collector of the IGBT 41 is connected to the positive electrode side voltage input terminal 10P, and the emitter of the IGBT 41 is connected to the intermediate terminal 10M and the reference potential terminal 10GU. The free wheeling diode 42 is connected in antiparallel with the IGBT 41. Specifically, the cathode of the free wheeling diode 42 is connected to the collector of the IGBT 41, and the anode of the free wheeling diode 42 is connected to the emitter of the IGBT 41.

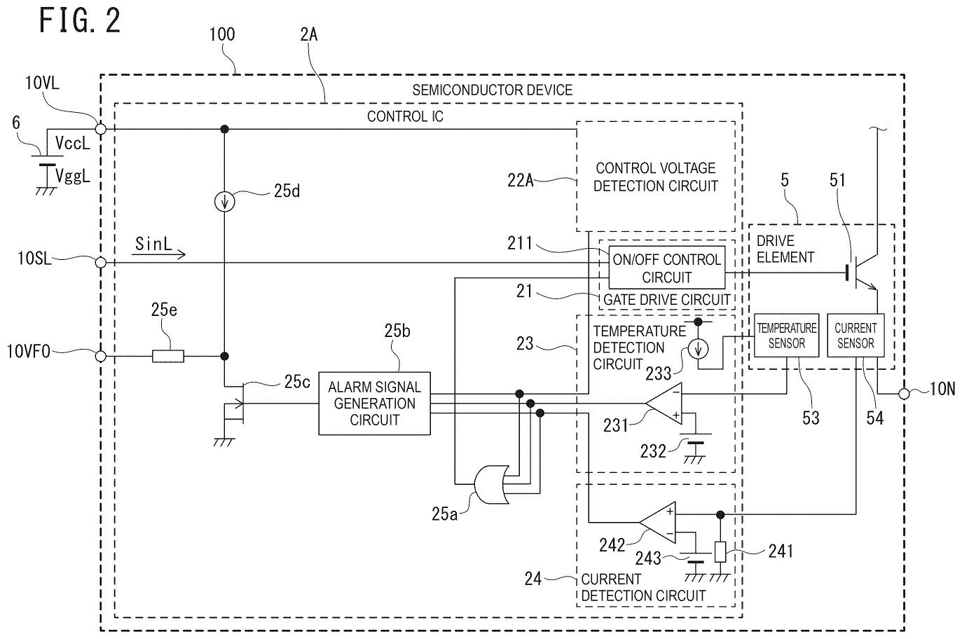

The drive element 5 has the IGBT 51, a free wheeling diode 52, a temperature sensor 53 (not illustrated in FIG. 1, see FIG. 2), and a current sensor 54 (not illustrated in FIG. 1, see FIG. 2). The temperature sensor 53 and the current sensor 54 will be specifically described later. The gate of the IGBT 51 is connected to the output terminal of the control IC 2A, the collector of the IGBT 51 is connected to the emitter of the IGBT 41, the anode of the free wheeling diode 42, the intermediate terminal 10M, and the reference potential terminal 10GU, and the emitter of the IGBT 51 is connected to the negative electrode side voltage input terminal 10N and the reference potential terminal 10GL. The free wheeling diode 52 is connected in antiparallel with the IGBT 51. Specifically, the cathode of the free wheeling diode 52 is connected to the collector of the IGBT 51, and the anode of the free wheeling diode 52 is connected to the emitter of the IGBT 51.

The IGBTs 41, 51 are controlled by the control IC 1 and IC 2A and are repeatedly turned on and off while the respective phases are reversed. Accordingly, the semiconductor device 100 is configured to supply AC power from the intermediate terminal 10M to a loading device such as a motor. As described above, the intermediate terminal 10M functions as the output terminal of AC power.

As described above, the semiconductor device 100 has the drive elements 4, 5 having the IGBTs 41, 51. The drive element 4 and the drive element 5 are connected in series between the positive electrode side voltage input terminal 10P and the negative electrode side voltage input terminal 10N. The drive element 4 is located on the side of the positive electrode side voltage input terminal 10P or on the high potential side. The drive element 5 is located on the side of the negative electrode side voltage input terminal 10N or on the low potential side. The semiconductor device 100 therefore includes the IGBT 41 (an example of the first switching element) and the IGBT 51 (an example of the second switching element) that is connected in series with the IGBT 41 and is located on the lower potential side than the IGBT 41.

The bootstrap circuit 3 is a circuit that generates a control power supply voltage VccU for the upper arm to be supplied to the control IC 1 by bootstrap operation using the control power supply voltage VccL for the lower arm supplied to the control IC 2A. The bootstrap circuit 3 has a bootstrap diode 31, a bootstrap capacitor 32, and a limiting resistor 33. One terminal of the limiting resistor 33 is connected through the power supply input terminal 10VL for the lower arm to the positive electrode side terminal of the voltage generation circuit 6. The other terminal of the limiting resistor 33 is connected to the anode of the bootstrap diode 31. The cathode of the bootstrap diode 31 is connected through the power supply input terminal 10VU for the upper arm to one electrode of the bootstrap capacitor 32. The other electrode of the bootstrap capacitor 32 is connected to the reference potential terminal 10GU for the upper arm. As described above, the bootstrap circuit 3 is located between the power supply input terminal 10VL for the lower arm and the reference potential terminal 10GU for the upper arm. The limiting resistor 33, the bootstrap diode 31, and the bootstrap capacitor 32 are connected in series between the power supply input terminal 10VL and the reference potential terminal 10GU.

The bootstrap operation will now be described. In FIG. 1, the bootstrap diode 31 is included in a charging path α for charging the bootstrap capacitor 32. The limiting resistor 33 limits the current flowing through the bootstrap diode 31. When the IGBT 41 is turned off, and the IGBT 51 is turned on, current flows along the charging path α, the bootstrap capacitor 32 is charged, and voltage is generated across the terminals. Next, when the IGBT 41 is turned on, and the IGBT 51 is turned off, the charge charged in the bootstrap capacitor 32 is discharged, and a voltage higher than the input voltage is generated on the upper side of the bootstrap capacitor 32. As a result, the gate potential of the IGBT 41 becomes higher than the emitter potential, and thus the IGBT 41 is driven.

### 1-2. Structure of Control IC Included in Semiconductor Device:

The control ICs 1, 2A in the semiconductor device 100 will be described by using the control IC 2A for the lower arm as an example. The control IC 1 for the upper arm includes neither the temperature detection circuit 23 nor the current detection circuit 24, which are included in the control IC 2A. The control IC 1 includes no structure for switching the determination voltage to detect the control power supply voltage during the initial charging period and after the end of the initial charging period, which is included in the control IC 2A. FIG. 2 is a block diagram schematically illustrating an example structure of the control IC 2A. In FIG. 2, the drive element 5 that is to be controlled by the control IC 2A is illustrated for easy understanding. In FIG. 2, the free wheeling diode 52 included in the drive element 5 is not illustrated.

As illustrated in FIG. 2, the control IC 2A has a gate drive circuit 21, a control voltage detection circuit 22A, a temperature detection circuit 23, a current detection circuit 24, an OR gate 25a, an alarm signal generation circuit 25b, a transistor 25c, a constant current source 25d, and a resistance element 25e.

The gate drive circuit 21 has an on/off control circuit 211. The on/off control circuit 211 is configured to drive the IGBT 51 included in the drive element 5 by, for example, PWM control, on the basis of an input signal SinL input from a controller (not illustrated) through the control signal input terminal 10SL.

The control voltage detection circuit (an example of the voltage reduction detection circuit) 22A included in the control IC 2A is a circuit that detects a reduction in the control power supply voltage VccL. Details will be described later, but when the control power supply voltage VccL input from the power supply input terminal 10VL is higher than a predetermined voltage, the control voltage detection circuit 22A outputs an output voltage of a low voltage level. In contrast, when the control power supply voltage VccL input from the power supply input terminal 10VL is lower than a predetermined voltage, the control voltage detection circuit 22A outputs an output voltage of a high voltage level. The predetermined voltage is set, for example, at the minimum voltage at which the gate drive circuit 21 is operable.

As illustrated in FIG. 2, the temperature detection circuit 23 has a comparator 231, a voltage generation circuit 232, and a constant current source 233. The voltage generation circuit 232, for example, is constituted by a DC power supply. The comparator 231, for example, has an operational amplifier. The negative electrode side of the voltage generation circuit 232 is connected to a reference potential terminal (for example, a ground terminal) of the semiconductor device 100. Accordingly, the voltage generation circuit 232 is connected to the reference potential terminal 10GL (see FIG. 1). The positive electrode side of the voltage generation circuit 232 is connected to the non-inverting input terminal (+) of the comparator 231. The inverting input terminal (−) of the comparator 231 is connected to the temperature sensor 53 included in the drive element 5. The temperature sensor 53 is constituted by, for example, a diode made of a silicon. The anode of the temperature sensor 53 is connected to the inverting input terminal (−) of the comparator 231, and the cathode of the temperature sensor 53 is connected to the reference potential terminal 10GL. The output terminal of the constant current source 233 is connected to the anode of the temperature sensor 53.

The forward voltage of a typical silicon diode is lower at high ambient temperatures than at low ambient temperatures. Hence, when a constant current is input from the constant current source 233 to the temperature sensor 53, the voltage reduction at a temperature sensor 53 decreases as the temperature of the IGBT 51 increases. Accordingly, the voltage input from the temperature sensor 53 to the temperature detection circuit 23 decreases as the temperature of the IGBT 51 increases.

The voltage output from the voltage generation circuit 232 is set to be higher than the voltage detected by the temperature sensor 53 when the temperature of the IGBT 51 is higher than the absolute maximum rated temperature. Hence, the comparator 231 outputs an output voltage of a low voltage level when the temperature of the IGBT 51 is lower than the absolute maximum rated temperature. The comparator 231 outputs an output voltage of a high voltage level when the temperature of the IGBT 51 is higher than the absolute maximum rated temperature. Hence, by using a voltage that is input from the temperature sensor 53 and changes according to the temperature of the IGBT 51, the temperature detection circuit 23 can detect whether the temperature of the IGBT 51 exceeds the absolute maximum rated temperature.

As illustrated in FIG. 2, the current detection circuit 24 has a resistance element 241, a comparator 242, and a voltage generation circuit 243. The resistance element 241 is connected between the current sensor 54 included in the drive element 5 and the reference potential terminal 10GL. The current sensor 54 outputs a detection current according to the current flowing through the IGBT 51. One terminal of the resistance element 241 is connected to the output terminal of the current sensor 54, and the other terminal of the resistance element 241 is connected to the reference potential terminal 10GL. The current detection circuit 24 is configured to detect, as the detection voltage, a voltage reduction caused in the resistance element 241 when the detection current output from the current sensor 54 flows through the resistance element 241. In other words, the current detection circuit 24 detects a voltage at one terminal of the resistance element 241 connected to the current sensor 54 as the detection voltage corresponding to the current flowing through the IGBT 51.

The voltage generation circuit 243, for example, has a DC power supply. The negative electrode side of the voltage generation circuit 243 is connected to a reference potential terminal (for example, a ground terminal) of the control IC 2A. Hence, the voltage generation circuit 243 is connected to the reference potential terminal 10GL. The positive electrode side of the voltage generation circuit 243 is connected to the inverting input terminal (−) of the comparator 242. The voltage generation circuit 243 is configured to generate a comparison voltage at a predetermined voltage level. The comparison voltage is set, for example, at a voltage corresponding to the absolute maximum rated current of the IGBT 51.

The non-inverting input terminal (+) of the comparator 242 is connected to the current sensor 54 and one terminal of the resistance element 241. The comparator 242 outputs an output voltage of a low voltage level when the detection voltage as a voltage reduction of the resistance element 241 is lower than a comparison voltage generated in the voltage generation circuit 243. The comparator 242 outputs an output voltage of a high voltage level when the detection voltage is higher than the comparison voltage.

The detection current output from the current sensor 54 is proportional to the current output from the IGBT 51. Hence, the current detection circuit 24 outputs an output signal of a low voltage level when the voltage corresponding to the detection current output from the current sensor 54 is lower than the voltage corresponding to the absolute maximum rated current of the IGBT 51 (i.e., when the IGBT 51 is in a normal state). In contrast, when the voltage corresponding to the detection current output from the current sensor 54 is higher than the voltage corresponding to the absolute maximum rated current of the IGBT 51 (i.e., when an excess current flows through the IGBT 51), the current detection circuit 24 outputs an output voltage of a high voltage level.

As illustrated in FIG. 2, one of three input terminals of the OR gate 25a is connected to the output terminal of the control voltage detection circuit 22A. Another of the three input terminals of the OR gate 25a is connected to the output terminal of the comparator 231 as the output terminal of the temperature detection circuit 23. The other input terminal of the OR gate 25a is connected to the output terminal of the comparator 242 as the output terminal of the current detection circuit 24. The output terminal of the OR gate 25a is connected to the on/off control circuit 211.

Hence, the OR gate 25a outputs an output voltage of a low voltage level to the on/off control circuit 211 when the control power supply voltage VccL, the current flowing through the IGBT 51, and the temperature of the IGBT 51 are each normal. In contrast, when at least one of the control power supply voltage VccL, the current flowing through the IGBT 51, and the temperature of the IGBT 51 is abnormal, the OR gate 25a outputs an output voltage of a high voltage level to the on/off control circuit 211.

The on/off control circuit 211 continues the operation based on the voltage level of the input signal SinL when the voltage level of the output voltage input from the OR gate 25a is a low level. In contrast, when the voltage level of the output voltage input from the OR gate 25a is a high level, the on/off control circuit 211 discontinues the operation of the IGBT 51 independent of the voltage level of the input signal SinL. Accordingly, the on/off control circuit 211 can be to discontinue the operation of the IGBT 51 when at least one of the control power supply voltage VccL, the current flowing through the IGBT 51, and the temperature of the IGBT 51 is abnormal.

As illustrated in FIG. 2, three input terminals of the alarm signal generation circuit 25b are connected in a one-to-one correspondence to the output terminal of the control voltage detection circuit 22A, the output terminal of the temperature detection circuit 23, and the output terminal of the current detection circuit 24. The transistor 25c located on the output side of the alarm signal generation circuit 25b, for example, is constituted by an N-type field-effect transistor. The gate of the transistor 25c is connected to the output terminal of the alarm signal generation circuit 25b. The drain of the transistor 25c is connected to the output terminal of the constant current source 25d. The source of the transistor 25c is connected to the reference potential terminal 10GL.

The alarm signal generation circuit 25b outputs an output voltage of a low voltage level to the gate of the transistor 25c when none of the control voltage detection circuit 22A, the temperature detection circuit 23, and the current detection circuit 24 detects abnormality. In contrast, when at least one of the control voltage detection circuit 22A, the temperature detection circuit 23, and the current detection circuit 24 detects abnormality, the alarm signal generation circuit 25b outputs an output voltage of a high voltage level to the gate of the transistor 25c only during a certain period. The alarm signal generation circuit 25b therefore outputs, to the gate of the transistor 25c, a pulsed output voltage in which the voltage level is a high level only during a certain period when at least one of the control IC 2A and the IGBT 51 changes from the normal state to the abnormal state.

Hence, the transistor 25c is turned off when none of the control voltage detection circuit 22A, the temperature detection circuit 23, and the current detection circuit 24 detects the abnormal state. In contrast, when at least one of the control voltage detection circuit 22A, the temperature detection circuit 23, and the current detection circuit 24 detects the abnormal state, the transistor 25c is turned on only during the alarm signal generation circuit 25b outputs an output voltage of a high voltage level.

To the connection between the drain of the transistor 25c and the output terminal of the constant current source 25d, one terminal of the resistance element 25e is connected. The other terminal of the resistance element 25e is connected to an alarm signal output terminal 10VFO included in the semiconductor device 100.

The alarm signal output terminal 10VFO is connected through the resistance element 25e to the drain of the transistor 25c and thus is an open drain output. When none of the control voltage detection circuit 22A, the temperature detection circuit 23, and the current detection circuit 24 detects the abnormal state, the output voltage output from the alarm signal generation circuit 25b is a low-level voltage, and thus the transistor 25c is turned off. Accordingly, the voltage of the alarm signal output terminal 10VFO is a high-level voltage. In contrast, when at least one of the control voltage detection circuit 22A, the temperature detection circuit 23, and the current detection circuit 24 detects the abnormal state, the output voltage output from the alarm signal generation circuit 25b is a high-level voltage, and thus the transistor 25c is turned on. Accordingly, the voltage of the alarm signal output terminal 10VFO is the potential of the reference potential terminal 10GL (for example, 0 V). As described above, the voltage of the alarm signal output terminal 10VFO is the inverted voltage of the output voltage output from the alarm signal generation circuit 25b. Accordingly, the alarm signal based on the output voltage output from the alarm signal generation circuit 25b is output from the alarm signal output terminal 10VFO.

### 1-3. Structure of Voltage Reduction Detection Circuit Included in Semiconductor Device:

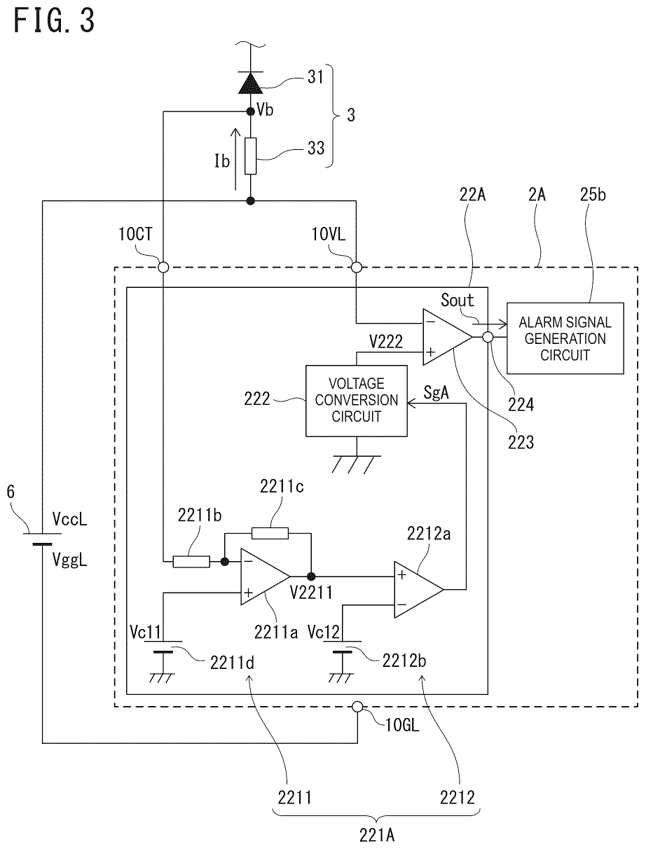

The voltage reduction detection circuit included in the second control circuit of the semiconductor device according to the present embodiment will be described by using FIG. 3 with reference to FIG. 1 and FIG. 2. FIG. 3 is a circuit block diagram schematically illustrating an example structure of the control voltage detection circuit (an example of the voltage reduction detection circuit) 22A in the present embodiment.

As illustrated in FIG. 3, the control voltage detection circuit 22A has a period detection circuit 221A, a voltage conversion circuit 222, a comparator 223, and a signal output terminal 224.

The period detection circuit 221A is a circuit that detects an initial charging period in which the bootstrap circuit 3 is initially charged by bootstrap operation. The period detection circuit 221A has a differential amplifier circuit 2211 and a comparator circuit 2212. The differential amplifier circuit 2211 is a circuit that amplifies a difference between a charging voltage Vb based on the charging current Ib flowing through the bootstrap circuit 3 and a comparison voltage Vc11 having a voltage level equivalent to the control power supply voltage VccL. The comparator circuit 2212 is a circuit that compares the output voltage V2211 output from the differential amplifier circuit 2211 with a comparison voltage Vc12.

The differential amplifier circuit 2211 has an amplifier 2211a, an input resistor 2211b, a feedback resistor 2211c, and a voltage generation circuit 2211d.

The voltage generation circuit 2211d, for example, is constituted by a DC power supply. The negative electrode side of the voltage generation circuit 2211d is connected to a reference potential terminal (for example, a ground terminal) of the semiconductor device 100. Accordingly, the negative electrode side of the voltage generation circuit 2211d has the same potential as the reference potential terminal 10GL. The voltage generation circuit 2211d is configured to output the same voltage as the voltage generation circuit 6. The voltage generation circuit 2211d and the voltage generation circuit 6 are configured to output the same voltage. However, the voltage generation circuit 2211d and the voltage generation circuit 6 may differ within the allowable error range of the respective outputs. Even in this case, the voltage generation circuit 2211d and the voltage generation circuit 6 are considered to output the same voltage. Hence, the comparison voltage Vc11 that is the voltage output by the voltage generation circuit 2211d is substantially the same voltage level as the control power supply voltage VccL that is the voltage output by the voltage generation circuit 6.

The amplifier 2211a, for example, is constituted by an operational amplifier. The non-inverting input terminal (+) of the amplifier 2211a is connected to the positive electrode side of the voltage generation circuit 2211d. The inverting input terminal (−) of the amplifier 2211a is connected to the other terminal of the input resistor 2211b and to the other terminal of the feedback resistor 2211c. The output terminal of the amplifier 2211a is connected to one terminal of the feedback resistor 2211c.

One terminal of the input resistor 2211b is connected to a charging voltage input terminal 10CT included in the control IC 2A. The charging voltage input terminal 10CT is connected to the anode of the bootstrap diode 31 included in the bootstrap circuit 3 and the other terminal of the limiting resistor 33. Accordingly, one terminal of the input resistor 2211b is connected through the charging voltage input terminal 10CT to the anode of the bootstrap diode 31 and to the other terminal of the limiting resistor 33. The charging voltage Vb input to the charging voltage input terminal 10CT corresponds to a voltage reduction generated in the limiting resistor 33 by the charging current Ib flowing through the limiting resistor 33. The charging current Ib is a current supplied from the voltage generation circuit 6 through the power supply input terminal 10VL. Accordingly, the charging voltage Vb is lower than the control power supply voltage VccL by a voltage reduction generated in the limiting resistor 33.

To the inverting input terminal (−) of the amplifier 2211a, the charging voltage Vb is input through the input resistor 2211b, and to the non-inverting input terminal (+) of the amplifier 2211a, the comparison voltage Vc11 is input. Hence, the differential amplifier circuit 2211 outputs an output voltage V2211 calculated as follows: a charging voltage Vb is subtracted from a comparison voltage Vc11 (or a control power supply voltage VccL) to give a difference voltage; a resistance value of the feedback resistor 2211c is divided by a resistance value of the input resistor 2211b to give a quotient; and the difference voltage is multiplied by the quotient to give the output voltage. As the amount of charge in the bootstrap capacitor 32 increases with time during the initial charging period, the charging current Ib decreases. Accordingly, the voltage reduction in the limiting resistor 33 decreases, and the charging voltage Vb increases. In other words, the voltage level of the charging voltage Vb approaches the voltage level of the control power supply voltage VccL with time during the initial charging period. As a result, the output voltage V2211 decreases with time during the initial charging period.

The comparator circuit 2212 has a comparator 2212a and a voltage generation circuit 2212b. The voltage generation circuit 2212b, for example, is constituted by a DC power supply. The negative electrode side of the voltage generation circuit 2212b is connected to a reference potential terminal (for example, a ground terminal) of the semiconductor device 100. Accordingly, the negative electrode side of the voltage generation circuit 2212b has the same potential as the reference potential terminal 10GL. The voltage generation circuit 2212b is configured to output a comparison voltage Vc12 having a voltage level calculated as follows: a resistance value of the feedback resistor 2211c is divided by a resistance value of the input resistor 2211b to give a quotient; and the quotient is added to a voltage level at which the output voltage V2211 output by the differential amplifier circuit 2211 is considered to be 0 bolt to give the voltage level of the comparison voltage Vc12. In other words, the comparison voltage Vc12 is set to have a voltage level calculated as follows: a voltage level at which the charging voltage Vb and the control power supply voltage VccL can be considered to be the same is amplified by an amplification factor based on the input resistor 2211b and the feedback resistor 2211c to give the voltage level of the comparison voltage.

The comparator 2212a, for example, is constituted by an operational amplifier. The non-inverting input terminal (+) of the comparator 2212a is connected to the output terminal of the differential amplifier circuit 2211 (i.e., the output terminal of the amplifier 2211a) and to one terminal of the feedback resistor 2211c. The inverting input terminal (−) of the comparator 2212a is connected to the positive electrode side of the voltage generation circuit 2212b. The output terminal of the comparator 2212a is connected to the voltage conversion circuit 222. Accordingly, the comparator circuit 2212 outputs a suggestion signal SgA (specifically described later) of a high signal level (i.e., a high voltage level) to the voltage conversion circuit 222 when the output voltage V2211 input from the differential amplifier circuit 2211 is higher than the comparison voltage Vc12. In contrast, when the output voltage V2211 input from the differential amplifier circuit 2211 is lower than the comparison voltage Vc12, the comparator circuit 2212 outputs a suggestion signal SgA of a low signal level (i.e., a low voltage level) to the voltage conversion circuit 222.

When the bootstrap capacitor 32 (see FIG. 1) is completely charged, the initial charging of the bootstrap circuit 3 is completed, and the charging current Ib flows no longer. Accordingly, the voltage level of the charging voltage Vb becomes substantially the same as the voltage level of the control power supply voltage VccL. Hence, the initial charging period until the initial charging is completed can be detected on the basis of the difference between the charging voltage Vb and the control power supply voltage VccL. In the present embodiment, therefore, in the period detection circuit 221A, the differential amplifier circuit 2211 calculates a difference between the charging voltage Vb and the comparison voltage Vc11; the comparator circuit 2212 compares the output voltage V2211 with the comparison voltage Vc12; and the end timing of the initial charging period is detected. As described above, in the present embodiment, the period detection circuit 221A detects the initial charging period on the basis of a difference between the charging voltage Vb based on the charging current Ib flowing through the bootstrap circuit 3 and the comparison voltage Vc11 that is substantially the same voltage level as the control power supply voltage VccL.

The voltage conversion circuit 222 is a circuit that increases the determination voltage V222 for determining a reduction in the control power supply voltage VccL, after the end of the initial charging period is detected by the period detection circuit 221A rather than before the end of the initial charging period is detected. The suggestion signal SgA output from the period detection circuit 221A indicates whether the initial charging period is completed on the basis of the signal level. In other words, a suggestion signal SgA of a high signal level indicates that the initial charging period is not completed. In contrast, a suggestion signal SgA of a low signal level indicates that the initial charging period is completed.

Hence, when a suggestion signal SgA input from the period detection circuit 221A is a high-level signal, the voltage conversion circuit 222 determines that the period detection circuit 221A does not detect the end of the initial charging period, and outputs a determination voltage V222 of a predetermined signal level (i.e., a predetermined voltage level). In contrast, when a suggestion signal SgA input from the period detection circuit 221A is a low-level signal, the voltage conversion circuit 222 determines that the period detection circuit 221A detects the end of the initial charging period, and outputs a determination voltage V222 of a higher signal level than that before the initial charging period is detected.

Details will be described later, but the control power supply voltage VccL during the initial charging period may decrease below the protection voltage for protecting the control IC 2A from a reduction in the control power supply voltage VccL when the control IC 2A drives a loading device such as a motor (not illustrated) by the drive element 5. The control IC 2A is also required to be protected from a reduction in the control power supply voltage VccL when the control IC 2A is performing initial charging operation by the bootstrap circuit 3. However, the protection voltage during the initial charging operation may be set lower than the protection voltage when a loading device such as a motor (not illustrated) is driven by the drive element 5. Hence, the voltage conversion circuit 222 outputs a higher determination voltage V222 set corresponding to the protection voltage after the end of the initial charging period than during the initial charging period.

As illustrated in FIG. 3, the comparator 223 located on the output power side of the control voltage detection circuit 22A, for example, is constituted by an operational amplifier. The non-inverting input terminal (+) of the comparator 223 is connected to the output terminal of the voltage conversion circuit 222. The inverting input terminal (−) of the comparator 223 is connected to the power supply input terminal 10VL. The output terminal of the comparator 223 is connected to the signal output terminal 224 included in the control voltage detection circuit 22A. The signal output terminal 224 is connected to the input terminal of the alarm signal generation circuit 25b and to the input terminal of the OR gate 25a (see FIG. 2). The signal output terminal 224 is a terminal that outputs an output signal Sout indicating, as a voltage level, whether the control power supply voltage VccL decreases.

Hence, the comparator 223 compares the determination voltage V222 input from the voltage conversion circuit 222 with the control power supply voltage VccL input through the power supply input terminal 10VL from the voltage generation circuit 6. The comparator 223 outputs an output signal of a low voltage level through the signal output terminal 224 to the alarm signal generation circuit 25b and the OR gate 25a when the control power supply voltage VccL is higher than the determination voltage V222 (i.e., normal operation). In contrast, when the control power supply voltage VccL is lower than the determination voltage V222 (i.e., abnormal operation), the comparator 223 outputs an output signal of a high voltage level through the signal output terminal 224 to the alarm signal generation circuit 25b and the OR gate 25a.

As described above, the voltage conversion circuit 222 outputs, to the comparator 223, a determination voltage V222 of a voltage level that differs whether the initial charging period is completed, and thus the comparator 223 can compare an optimum determination voltage V222 and a control power supply voltage VccL depending on whether the initial charging period is completed. Accordingly, the control voltage detection circuit 22A can appropriately detect whether the control IC 2A is required to be protected from a reduction in the control power supply voltage VccL during both the initial charging period and the control voltage stable period after the end of the initial charging period.

### 1-4. Operation of Semiconductor Device:

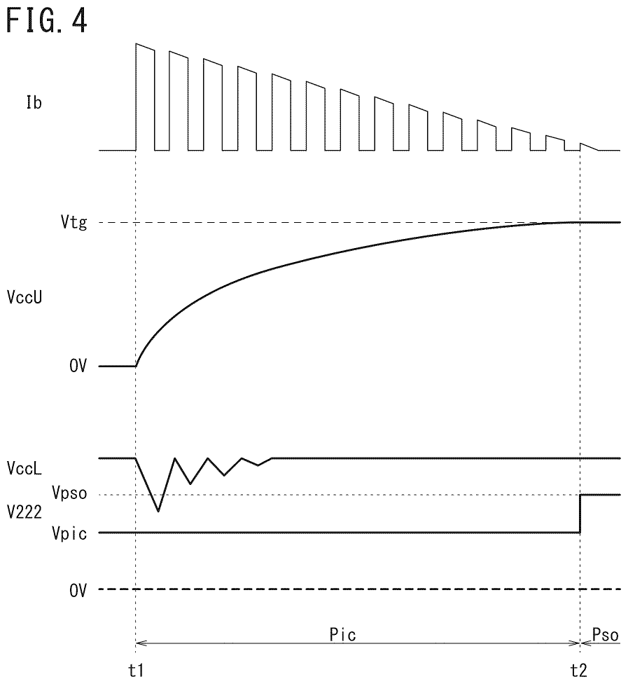

As an example operation of the semiconductor device according to the present embodiment, protection operation of the control IC from a reduction in the control power supply voltage in bootstrap operation will be described by using FIG. 4 with reference to FIG. 1 to FIG. 3. FIG. 4 is a view schematically illustrating waveforms of charging current, control power supply voltage for the upper arm, and control power supply voltage for the lower arm in bootstrap operation. “Ib” in FIG. 4 indicates charging current, “VccU” in FIG. 4 indicates control power supply voltage for the upper arm, and “VccL” in FIG. 4 indicates control power supply voltage for the lower arm. “V222” in FIG. 4 indicates determination voltage output from the voltage conversion circuit 222, “Pic” in FIG. 4 indicates initial charging period, and “Pso” in FIG. 4 indicates control voltage stable period after the initial charging period.

In the semiconductor device 100 according to the present embodiment, while the control IC 1 controls the drive element 4 to be in the off state, the IC 2A controls the drive element 5 to be in the on state and the off state repeatedly, and this starts bootstrap operation. When the drive element 5 is controlled to be in the on state, the charging path α in FIG. 1 is formed.

The charging path α is a path through which current flows through the voltage generation circuit 6, the power supply input terminal 10VL, the limiting resistor 33, the bootstrap diode 31, the bootstrap capacitor 32, the reference potential terminal 10GU, the IGBT 51, the reference potential terminal 10GL, and the voltage generation circuit 6 in this order. When charging current Ib flows through the charging path α, the bootstrap capacitor 32 is charged. Specifically, the voltage between the two electrodes of the bootstrap capacitor 32 is maintained at a potential difference between the control power supply voltage VccL and the reference potential VggU for the upper arm by charging through the charging path α. Hence, the control power supply voltage VccU supplied to the power supply input terminal 10VU is set at a voltage higher than the reference potential of the reference potential terminal 10GU by the control power supply voltage VccL. As described above, the semiconductor device 100 generates the control power supply voltage VccU for the upper arm by bootstrap operation using the IGBT 51 and the bootstrap circuit 3.

In the present embodiment, when the drive element 5 is repeatedly turned into the on state and the off state in bootstrap operation, the bootstrap capacitor 32 is charged. In this case, the charging current Ib flowing through the bootstrap circuit 3 has a pulsed current waveform. The pulsed charging current Ib has a current waveform of a larger current value as the amount of charge is smaller in the bootstrap capacitor 32. As illustrated in FIG. 4, at time t1 when the bootstrap capacitor 32 is not charged and the control power supply voltage VccU is 0 V (i.e., the same potential as the reference potential terminal 10GU), initial charging is started. During the initial charging period Pic, the current value of the charging current Ib is maximum at time t1. As the drive element 5 is repeatedly turned into the on state and the off state over time from time t1, the amount of charge in the bootstrap capacitor 32 increases, and the control power supply voltage VccU increases. Accordingly, the current value of the charging current Ib gradually decreases.

By the charging current Ib flowing, the control power supply voltage VccL fluctuates. As illustrated in FIG. 4, the control power supply voltage VccL greatly fluctuates as the current value of the charging current Ib is higher. Hence, the fluctuation of the control power supply voltage VccL is maximum at time t1 and then decreases as the drive element 5 is repeatedly turned into the on state and the off state over time from time t1. The voltage conversion circuit 222 in the embodiment (see FIG. 3) is set such that the voltage level Vpic of the determination voltage V222 is lower than the voltage level of the control power supply voltage VccL at the maximum fluctuation. Hence, the semiconductor device 100 is prevented from discontinuing by control voltage reduction protection during the initial charging period Pic.

The output voltage V2211 output from the differential amplifier circuit 2211 (see FIG. 3) is highest at time t1 at which the charging voltage Vb is highest, and decreases as the drive element 5 is repeatedly turned into the on state and the off state over time from time t1. When the amount of charge in the bootstrap capacitor 32 reaches the maximum value, and the control power supply voltage VccU reaches a target level Vtg, the output voltage V2211 output from the differential amplifier circuit 2211 (see FIG. 3) decreases below the comparison voltage Vc12. Accordingly, for example, at time t2, the voltage level of the suggestion signal SgA output from the period detection circuit 221A changes from a high level to a low level. As a result, at time t2, the determination voltage V222 output from the voltage conversion circuit 222 is a voltage level Vpso that is higher than the voltage level Vpic during the initial charging period Pic. Accordingly, during a control voltage stable period Pso after the end of the initial charging period Pic, the semiconductor device 100 detects a reduction in the control power supply voltage VccL by the determination voltage V222 of the voltage level Vpso and enables protection operation of a control power supply voltage reduction.

### 1-5. Effect of Semiconductor Device:

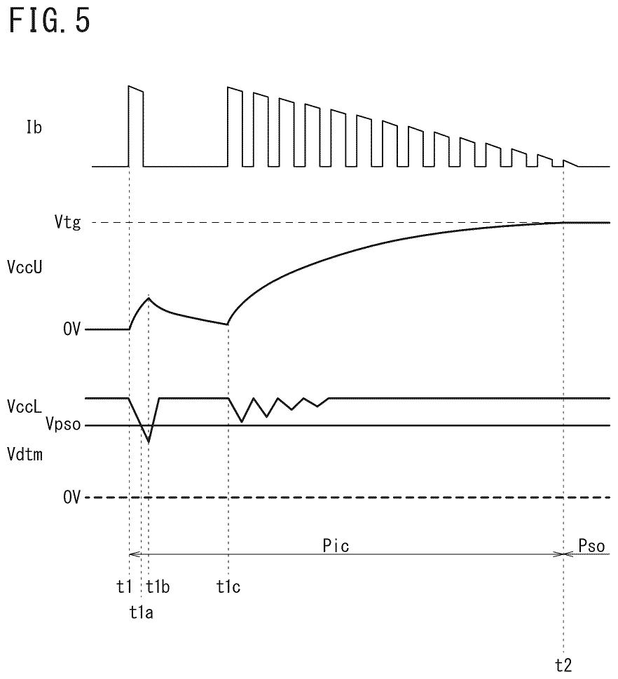

The effect of the semiconductor device according to the present embodiment will be described by using FIG. 5 with reference to FIG. 1 to FIG. 4. In a conventional semiconductor device, a control power supply voltage for the upper arm is generated by bootstrap operation as with the semiconductor device 100, but the period detection circuit 221A and the voltage conversion circuit 222 (see FIG. 3) in the present embodiment are not included in the control voltage detection circuit. Hence, in a conventional semiconductor device, a determination voltage input to a comparator corresponding to the comparator 223 (see FIG. 3) during the initial charging period is set at the voltage level during the control voltage stable period after the end of the initial charging period.

FIG. 5 is a view schematically illustrating waveforms of charging current, control power supply voltage for the upper arm, and control power supply voltage for the lower arm in bootstrap operation of a conventional semiconductor device. “Ib” in FIG. 5 indicates charging current, “VccU” in FIG. 5 indicates control power supply voltage for the upper arm, and “VccL” in FIG. 5 indicates control power supply voltage for the lower arm. “Vdtm” in FIG. 5 indicates determination voltage input to the comparator, “Pic” in FIG. 5 indicates initial charging period, and “Pso” in FIG. 5 indicates control voltage stable period.

As described above, the determination voltage Vdtm is set at the same voltage level Vpso during the initial charging period Pic and the control voltage stable period Pso after the end of the initial charging period Pic. The voltage level Vpso is, for example, the same as the voltage level Vpso (see FIG. 4) of the determination voltage V222 in the present embodiment. As illustrated in FIG. 5, at time t1a after time t1 at which bootstrap operation is started, if the control power supply voltage VccL for the lower arm decreases below the determination voltage Vdtm, protection of the control power supply voltage reduction is activated. Accordingly, at time t1b, a certain time period after time t1a, the bootstrap operation discontinues, and thus the control power supply voltage VccU for the upper arm decreases. At time t1c, a certain time period after time t1b, the bootstrap operation restarts. At time t2, the voltage level of the control power supply voltage VccU reaches a target level Vtg, and the bootstrap operation is completed.

As described above, in a conventional semiconductor device, the voltage level Vpso of the determination voltage Vdtm during the initial charging period Pic is set at the same voltage level as during the control voltage stable period Pso. Hence, by bootstrap operation when the amount of charge in a bootstrap capacitor is small(for example, operation at time t1 illustrated in FIG. 5), the control power supply voltage VccL decreases below the determination voltage Vdtm, and thus the bootstrap operation may temporarily discontinue. As a result, in a conventional semiconductor device, a problem in that the initial charging period Pic becomes long occurs.

In contrast, in the semiconductor device 100 according to the present embodiment, the voltage level Vpic of the determination voltage V222 during the initial charging period Pic is set to be lower than the voltage level Vpso during the control voltage stable period Pso. Accordingly, the semiconductor device 100 can suppress unintended activation of the reduction protection of control power supply voltage VccL during the initial charging period Pic, and this prevents prolonged initial charging time. In addition, in the semiconductor device 100, the voltage level Vpso of the determination voltage V222 during the control voltage stable period Pso is set to be higher than the voltage level Vpic. This enables protection operation against a reduction in the control power supply voltage as with a conventional semiconductor device.

As described above, the semiconductor device 100 according to the present embodiment includes the IGBT 41, the IGBT 51 connected in series with the IGBT 41 and provided on the lower potential side than the IGBT 41, the control IC 1 configured to control drive operation of the IGBT 41, the control IC 2A configured to control drive operation of the IGBT 51 and protection operation of the IGBT 41 and the IGBT 51, and the bootstrap circuit 3 configured to generate a control power supply voltage VccU supplied to the control IC 1 by bootstrap operation using a control power supply voltage VccL supplied to the control IC 2A. The control IC 2A has the control voltage detection circuit 22A configured to detect a reduction in the control power supply voltage VccL, and the control voltage detection circuit 22A has the period detection circuit 221A configured to detect an initial charging period in which the bootstrap circuit 3 is initially charged by the bootstrap operation.

Accordingly, the semiconductor device 100 can suppress unintended activation of the reduction protection of control power supply voltage during the initial charging period and enables the reduction protection of control power supply voltage during the stable period of the control power supply voltage.

### 1-5. Alternative Embodiment:

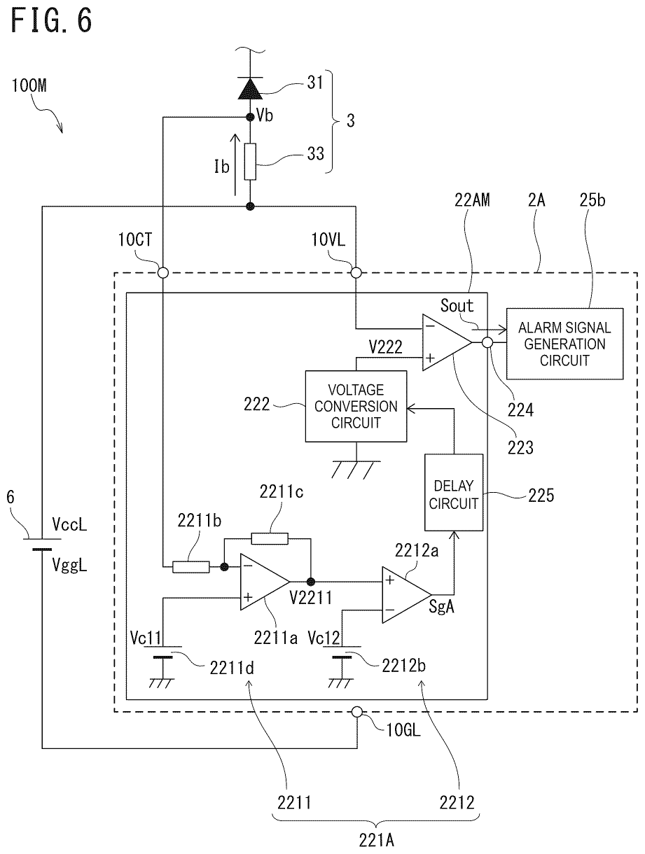

A semiconductor device according to an alternative embodiment of the present embodiment will be described by using FIG. 6 with reference to FIG. 1 and FIG. 2. The semiconductor device according to the present alternative embodiment has substantially the same structure as the semiconductor device 100 according to the present embodiment except the structure of a control voltage detection circuit. Hence, of the components of the semiconductor device according to the present alternative embodiment, a component having a similar action or function to that of the semiconductor device 100 according to the present embodiment is indicated by an identical sign and is not described. FIG. 6 is a circuit block diagram schematically illustrating an example structure of a control voltage detection circuit (an example of the voltage reduction detection circuit) 22AM in the present alternative embodiment.

As illustrated in FIG. 6, a control voltage detection circuit 22AM included in a semiconductor device 100M according to the present alternative embodiment has a delay circuit 225 configured to delay, by a predetermined period, a suggestion signal SgA that is input from a period detection circuit 221A and indicates that the end of the initial charging period has been detected, and to output the delayed signal to a voltage conversion circuit 222. The input terminal of the delay circuit 225 is connected to the output terminal of a comparator 2212a included in the period detection circuit 221A. The output terminal of the delay circuit 225 is connected to the input terminal of the voltage conversion circuit 222. Accordingly, the delay circuit 225 delays a suggestion signal SgA input from the comparator 2212a by a predetermined period and outputs the delayed signal to the voltage conversion circuit 222.

Hence, the timing at which the voltage conversion circuit 222 converts a voltage level of the determination voltage V222 after the period detection circuit 221A detects the initial charging period is delayed by the delay amount in the delay circuit 225 as compared with the timing in the present embodiment. Accordingly, the semiconductor device 100M can more reliably convert a voltage level of the determination voltage V222 after the end of the initial charging period as compared with the semiconductor device 100. As a result, the semiconductor device 100M can more reliably suppress unintended activation of the reduction protection of control power supply voltage during the initial charging period and enables the reduction protection of control power supply voltage during the stable period of the control power supply voltage.

### Second Embodiment

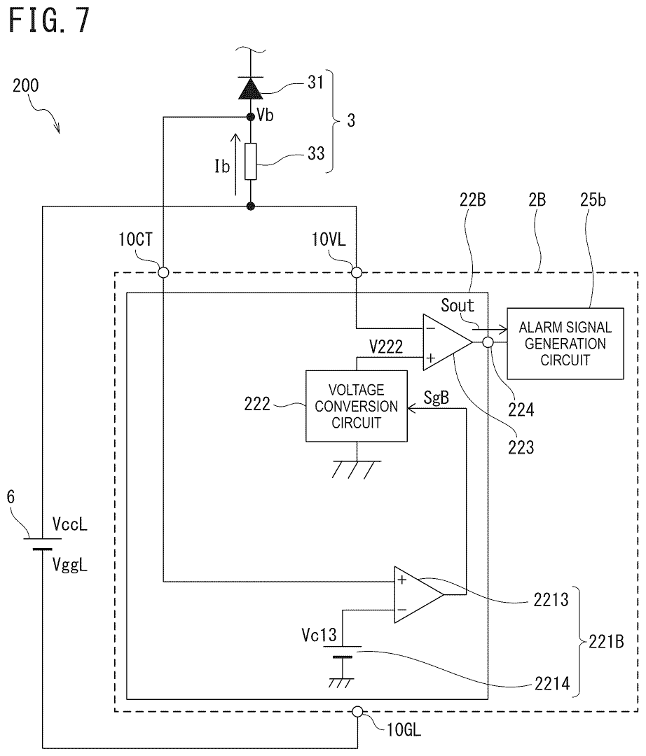

A semiconductor device according to a second embodiment of the present disclosure will be described by using FIG. 7. The semiconductor device according to the present embodiment has substantially the same structure as the semiconductor device 100 according to the first embodiment except the structure of a control voltage detection circuit. Hence, of the components of the semiconductor device according to the present embodiment, a component having a similar action or function to that of the semiconductor device 100 according to the first embodiment is indicated by an identical sign and is not described.

### 2-1. Entire Structure of Semiconductor Device:

A semiconductor device 200 according to the present embodiment has substantially the same entire structure as the semiconductor device 100 according to the first embodiment, and thus the entire structure is not described.

### 2-2. Structure of Control IC Included in Semiconductor Device:

A control IC for the upper arm (an example of the first control circuit) included in the semiconductor device 200 according to the present embodiment has substantially the same structure as the control IC 1 for the upper arm in the first embodiment and is not described.

A control IC 2B for the lower arm (an example of the second control circuit) included in the semiconductor device 200 according to the present embodiment has substantially the same structure as the control IC 2A for the lower arm in the first embodiment except the structure of a voltage reduction detection circuit. Hence, the entire structure of the control IC 2B for the lower arm included in the semiconductor device 200 according to the present embodiment is not described.

### 2-3. Structure of Voltage Reduction Detection Circuit Included in Semiconductor Device:

A control voltage detection circuit (an example of the voltage reduction detection circuit) 22B included in the control IC 2B of the semiconductor device 200 according to the present embodiment will be described by using FIG. 7. FIG. 7 is a circuit block diagram schematically illustrating an example structure of the control voltage detection circuit 22B in the present embodiment.

As illustrated in FIG. 7, the control voltage detection circuit 22B has a period detection circuit 221B, a voltage conversion circuit 222, a comparator 223, and a signal output terminal 224.

The period detection circuit 221B is a circuit that detects an initial charging period in which the bootstrap circuit 3 is initially charged by bootstrap operation. The period detection circuit 221B has a comparator 2213 and a voltage generation circuit 2214. The voltage generation circuit 2214, for example, is constituted by a DC power supply. The negative electrode side of the voltage generation circuit 2214 is connected to a reference potential terminal (for example, a ground terminal) of the semiconductor device 200. Accordingly, the negative electrode side of the voltage generation circuit 2214 has the same potential as the reference potential terminal 10GL. The voltage generation circuit 2214 is configured to output a comparison voltage Vc13 lower than the control power supply voltage VccL by a predetermined value. The predetermined value is set at a voltage having the same voltage level as the voltage generated by a predetermined charging current Ib flowing, for example, through a limiting resistor 33.

The comparator 2213, for example, is constituted by an operational amplifier. The non-inverting input terminal (+) of the comparator 2213 is connected to a charging voltage input terminal 10CT. The inverting input terminal (−) of the comparator 2213 is connected to the positive electrode side of the voltage generation circuit 2214. The output terminal of the comparator 2213 is connected to the voltage conversion circuit 222. Accordingly, the comparator 2213 outputs a suggestion signal SgB of a high signal level (i.e., a high voltage level) to the voltage conversion circuit 222 when a charging voltage Vb input through the charging voltage input terminal 10CT from the bootstrap circuit 3 is higher than the comparison voltage Vc13. In contrast, when a charging voltage Vb input through the charging voltage input terminal 10CT from the bootstrap circuit 3 is lower than the comparison voltage Vc13, the comparator 2213 outputs a suggestion signal SgB of a low signal level (i.e., a low voltage level) to the voltage conversion circuit 222.

When the bootstrap capacitor 32 (see FIG. 1) is completely charged, the initial charging of the bootstrap circuit 3 is completed, and the charging current Ib flows no longer. Accordingly, the voltage level of the charging voltage Vb becomes substantially the same as the voltage level of the control power supply voltage VccL. Hence, the initial charging period until the initial charging is completed can be detected on the basis of the comparison between the charging voltage Vb and the comparison voltage Vc13. In the present embodiment, therefore, the period detection circuit 221B detects the initial charging period on the basis of a charging voltage Vb based on the charging current Ib flowing through the bootstrap circuit 3.

As described in the first embodiment, the charging voltage Vb corresponds to a voltage reduction generated in the limiting resistor 33 by a charging current Ib flowing through the limiting resistor 33 and is lower than the control power supply voltage VccL by the voltage reduction. While the bootstrap operation by the bootstrap circuit 3 proceeds, the charging current Ib decreases as the charge amount charged in the bootstrap capacitor 32 increases. Accordingly, the voltage reduction in the limiting resistor 33 decreases as the bootstrap operation by the bootstrap circuit 3 proceeds. Hence, the charging voltage Vb increases as the bootstrap operation proceeds and reaches substantially the same voltage as the control power supply voltage VccL when the initial charging period is completed.

Hence, the period detection circuit 221B outputs, to the voltage conversion circuit 222, a suggestion signal SgB having a low signal level (i.e., a low voltage level) and indicating that the initial charging period is not completed, when a charging voltage Vb is lower than the comparison voltage Vc13. In contrast, when a charging voltage Vb is higher than the comparison voltage Vc13, the period detection circuit 221B outputs, to the voltage conversion circuit 222, a suggestion signal SgB having a high signal level (i.e., a high voltage level) and indicating that the initial charging period is completed.

The voltage conversion circuit 222 is a circuit that increases the determination voltage V222 for determining a reduction in the control power supply voltage VccL, after the end of the initial charging period is detected by the period detection circuit 221B rather than before the end of the initial charging period is detected. The suggestion signal SgB output from the period detection circuit 221B indicates whether the initial charging period is completed on the basis of the signal level. In other words, a suggestion signal SgB of a low signal level indicates that the initial charging period is not completed. In contrast, a suggestion signal SgB of a high signal level indicates that the initial charging period is completed.

Hence, when a suggestion signal SgB input from the period detection circuit 221B is a low-level signal, the voltage conversion circuit 222 determines that the period detection circuit 221B does not detect the end of the initial charging period, and outputs a determination voltage V222 of a predetermined signal level (i.e., a predetermined voltage level). In contrast, when a suggestion signal SgB input from the period detection circuit 221B is a high-level signal, the voltage conversion circuit 222 determines that the period detection circuit 221B detects the end of the initial charging period, and outputs a determination voltage V222 of a higher signal level than that before the initial charging period is detected.

The voltage conversion circuit 222 outputs, to the comparator 223, a determination voltage V222 of a voltage level that differs whether the initial charging period is completed. Hence, the comparator 223 can compare an optimum determination voltage V222 and a control power supply voltage VccL depending on whether the initial charging period is completed. Accordingly, as with the control voltage detection circuit 22A in the first embodiment, the control voltage detection circuit 22B can appropriately detect whether the control IC 2B is required to be protected from a reduction in the control power supply voltage VccL during both the initial charging period and the control voltage stable period after the end of the initial charging period.

### 2-4. Operation of Semiconductor Device:

In bootstrap operation as an example operation of the semiconductor device 200 according to the present embodiment, the operation of protecting the control IC 2B from a reduction in the control power supply voltage is substantially the same as the protection operation in the semiconductor device 100 according to the first embodiment except the method of detecting the end of the initial charging period in the period detection circuit 221B. Hence, the operation of the semiconductor device 200 is not described.

### 2-5. Effect of Semiconductor Device:

The semiconductor device according to the present embodiment can detect a reduction in the control power supply voltage VccL by a determination voltage V222 of a voltage level that differs between during the initial charging period and after the end of the initial charging period, and thus achieves substantially the same effect as the semiconductor device 100 according to the first embodiment.

As described above, the semiconductor device 200 according to the present embodiment includes the IGBT 41, the IGBT 51 connected in series with the IGBT 41 and provided on a lower potential side of the IGBT 41, the control IC 1 configured to control drive operation of the IGBT 41, the control IC 2B configured to control drive operation of the IGBT 51 and protection operation of the IGBT 41 and the IGBT 51, and the bootstrap circuit 3 configured to generate a control power supply voltage VccU supplied to the control IC 1 by bootstrap operation using a control power supply voltage VccL supplied to the control IC 2B. The control IC 2B has the control voltage detection circuit 22B configured to detect a reduction in the control power supply voltage VccL, and the control voltage detection circuit 22B has the period detection circuit 221B configured to detect an initial charging period in which the bootstrap circuit 3 is initially charged by the bootstrap operation.

Accordingly, the semiconductor device 200 according to the present embodiment can suppress unintended activation of the reduction protection of control power supply voltage during the initial charging period and enables the reduction protection of control power supply voltage during the stable period of the control power supply voltage.

### 2-5. Alternative Embodiment:

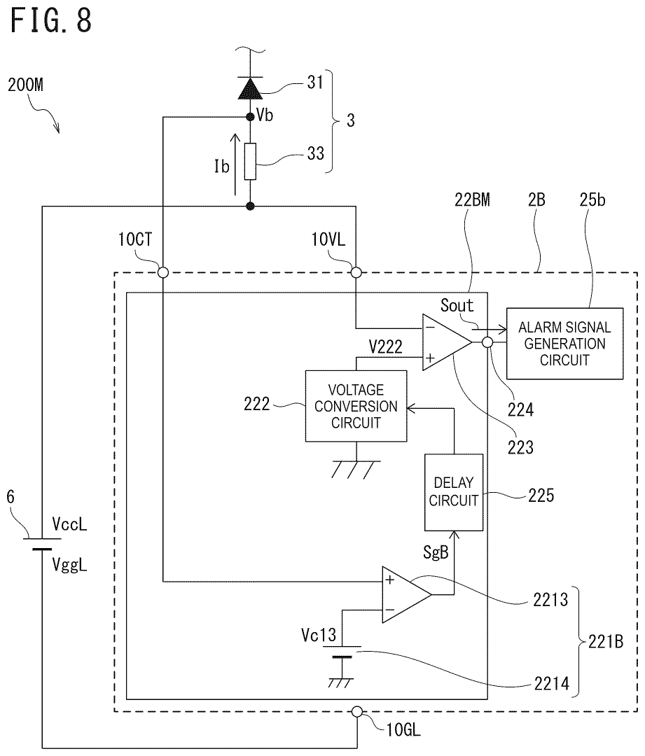

A semiconductor device according to an alternative embodiment of the present embodiment will be described by using FIG. 8. The semiconductor device according to the present alternative embodiment has substantially the same structure as the semiconductor device 200 according to the present embodiment except the structure of a control voltage detection circuit. Hence, of the components of the semiconductor device according to the present alternative embodiment, a component having a similar action or function to that of the semiconductor device 200 according to the present embodiment is indicated by an identical sign and is not described. FIG. 8 is a circuit block diagram schematically illustrating an example structure of a control voltage detection circuit (an example of the voltage reduction detection circuit) 22BM in the present alternative embodiment.

As illustrated in FIG. 8, the control voltage detection circuit 22BM included in a semiconductor device 200M according to the present alternative embodiment has a delay circuit configured to delay, by a predetermined period, a suggestion signal SgB that is input from a period detection circuit 221B and indicates that the end of the initial charging period has been detected, and to output the delayed signal to a voltage conversion circuit 222. The input terminal of the delay circuit 225 is connected to the output terminal of a comparator 2213 included in the period detection circuit 221B. The output terminal of the delay circuit 225 is connected to the input terminal of the voltage conversion circuit 222. Accordingly, the delay circuit 225 delays a suggestion signal SgB input from the comparator 2213 by a predetermined period and outputs the delayed signal to the voltage conversion circuit 222.

Hence, the timing at which the voltage conversion circuit 222 converts a voltage level of the determination voltage V222 after the period detection circuit 221B detects the initial charging period is delayed by the delay amount in the delay circuit 225 as compared with the timing in the present embodiment. Accordingly, the semiconductor device 200M can convert a voltage level of the determination voltage V222 more reliably after the end of the initial charging period as compared with the semiconductor device 200. As a result, the semiconductor device 200M can suppress unintended activation of the reduction protection of control power supply voltage during the initial charging period and enables the reduction protection of control power supply voltage during the stable period of the control power supply voltage.

### Third Embodiment

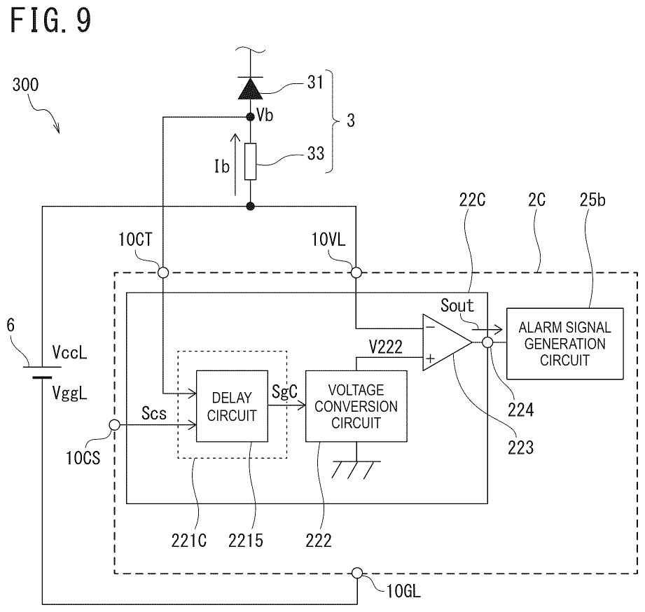

A semiconductor device according to a third embodiment of the present disclosure will be described by using FIG. 9. The semiconductor device according to the present embodiment has substantially the same structure as the semiconductor device 100 according to the first embodiment except the structure of a control voltage detection circuit. Hence, of the components of the semiconductor device according to the present embodiment, a component having a similar action or function to that of the semiconductor device 100 according to the first embodiment is indicated by an identical sign and is not described.

### 3-1. Entire Structure of Semiconductor Device:

A semiconductor device 300 according to the present embodiment has substantially the same entire structure as the semiconductor device 100 according to the first embodiment, and thus the entire structure is not described.

### 3-2. Structure of Control IC Included in Semiconductor Device:

A control IC for the upper arm (an example of the first control circuit) included in the semiconductor device 300 according to the present embodiment has substantially the same structure as the control IC 1 for the upper arm in the first embodiment and is not described.

A control IC 2C for the lower arm (an example of the second control circuit) included in the semiconductor device 300 according to the present embodiment has substantially the same structure as the control IC 2A for the lower arm in the first embodiment except the structure of a voltage reduction detection circuit. Hence, the entire structure of the control IC 2C for the lower arm included in the semiconductor device 300 according to the present embodiment is not described.

### 3-3. Structure of Voltage Reduction Detection Circuit Included in Semiconductor Device:

A control voltage detection circuit (an example of the voltage reduction detection circuit) 22C included in the control IC 2C of the semiconductor device 300 according to the present embodiment will be described by using FIG. 9. FIG. 9 is a circuit block diagram schematically illustrating an example structure of the control voltage detection circuit 22C in the present embodiment.

As illustrated in FIG. 9, the control voltage detection circuit 22C has a period detection circuit 221C, a voltage conversion circuit 222, a comparator 223, and a signal output terminal 224.

The period detection circuit 221C is a circuit that detects an initial charging period in which the bootstrap circuit 3 is initially charged by bootstrap operation. The period detection circuit 221C includes a delay circuit 2215 configured to delay, by a predetermined period, a charging start signal Scs indicating the start of initial charging to the bootstrap circuit 3 and to output, to the voltage conversion circuit 222, the delayed charging start signal Scs as a suggestion signal SgC indicating that the end of the initial charging period is detected.

The delay circuit 2215 has two input terminals. One of the two input terminals is connected to a start signal input terminal 10CS included in the control IC 2C, and the other input terminal is connected to a charging voltage input terminal 10CT. Accordingly, to the delay circuit 2215, a charging start signal Scs is input through the start signal input terminal 10CS, and a charging voltage Vb is input through the charging voltage input terminal 10CT. The charging start signal Scs is, for example, input from a controller (not illustrated) that controls the semiconductor device 300 and outputs input signals SinU, SinL (see FIG. 1).

In the delay circuit 2215, a time period corresponding to the initial charging period is previously set. In the delay circuit 2215, the timing at which a charging voltage Vb is first input through the charging voltage input terminal 10CT after a charging start signal Scs is input through the start signal input terminal 10CS is regarded as the initial charging period start timing. The delay circuit 2215 starts measuring the elapsed time of the initial charging period from the start timing. When measuring, as the elapsed time, a time equal to the time period corresponding to the initial charging period, the delay circuit 2215 outputs a charging start signal Scs as the suggestion signal SgC to the voltage conversion circuit 222.

The signal level of the charging start signal Scs changes from a low level to a high level, for example, at the start of the initial charging. From the start of measuring the elapsed time of the initial charging period until the time corresponding to the initial charging period has elapsed, the time period set in the delay circuit 2215 has not elapsed. Hence, the period detection circuit 221C outputs, to the voltage conversion circuit 222, a suggestion signal SgC of, for example, a low signal level (i.e., a low voltage level) indicating that the initial charging period is not completed. In contrast, after the time corresponding to the initial charging period has elapsed from the start of measuring the elapsed time of the initial charging period, the time period set in the delay circuit 2215 has elapsed. Hence, the period detection circuit 221C outputs, to the voltage conversion circuit 222, a suggestion signal SgC of, for example, a high signal level (i.e., a high voltage level) that is a delayed charging start signal Scs and indicates that the initial charging period is completed.

The voltage conversion circuit 222 is a circuit that increases the determination voltage V222 for determining a reduction in the control power supply voltage VccL, after the end of the initial charging period is detected by the period detection circuit 221B rather than before the end of the initial charging period is detected. The suggestion signal SgC output from the period detection circuit 221C indicates whether the initial charging period is completed on the basis of the signal level. In other words, a suggestion signal SgC of a low signal level indicates that the initial charging period is not completed. In contrast, a suggestion signal SgC of a high signal level indicates that the initial charging period is completed.

Hence, when a suggestion signal SgC input from the period detection circuit 221C is a low-level signal, the voltage conversion circuit 222 determines that the period detection circuit 221C does not detect the end of the initial charging period, and outputs a determination voltage V222 of a predetermined signal level (i.e., a predetermined voltage level). In contrast, when a suggestion signal SgC input from the period detection circuit 221C is a high-level signal, the voltage conversion circuit 222 determines that the period detection circuit 221C detects the end of the initial charging period, and outputs a determination voltage V222 of a higher signal level than that before the end of the initial charging period is detected.

The voltage conversion circuit 222 outputs, to the comparator 223, a determination voltage V222 of a voltage level that differs whether the initial charging period is completed. Hence, the comparator 223 can compare an optimum determination voltage V222 and a control power supply voltage VccL depending on whether the initial charging period is completed. Accordingly, as with the control voltage detection circuit 22A in the first embodiment, the control voltage detection circuit 22C can appropriately detect whether the control IC 2C is required to be protected from a reduction in the control power supply voltage VccL both during the initial charging period and after the end of the initial charging period.

### 3-4. Operation of Semiconductor Device:

In bootstrap operation as an example operation of the semiconductor device 300 according to the present embodiment, the operation of protecting the control IC 2C from a reduction in the control power supply voltage is substantially the same as the protection operation in the semiconductor device 100 according to the first embodiment except the method of detecting the end of the initial charging period in the period detection circuit 221C. Hence, the operation of the semiconductor device 300 is not described.

### 3-5. Effect of Semiconductor Device:

The semiconductor device 300 according to the present embodiment can detect a reduction in the control power supply voltage VccL by a determination voltage V222 of a voltage level that differs between during the initial charging period and after the end of the initial charging period, and thus achieves substantially the same effect as the semiconductor device 100 according to the first embodiment.

As described above, the semiconductor device 300 according to the present embodiment includes the IGBT 41, the IGBT 51 connected in series with the IGBT 41 and provided on a lower potential side than the IGBT 41, the control IC 1 configured to control drive operation of the IGBT 41, the control IC 2C configured to control drive operation of the IGBT 51 and protection operation of the IGBT 41 and the IGBT 51, and the bootstrap circuit 3 configured to generate a control power supply voltage VccU supplied to the control IC 1 by bootstrap operation using a control power supply voltage VccL supplied to the control IC 2C. The control IC 2C has the control voltage detection circuit 22C configured to detect a reduction in the control power supply voltage VccL, and the control voltage detection circuit 22C has the period detection circuit 221C configured to detect an initial charging period in which the bootstrap circuit 3 is initially charged by the bootstrap operation.

Accordingly, the semiconductor device 300 according to the present embodiment can suppress unintended activation of the reduction protection of control power supply voltage during the initial charging period and enables the reduction protection of control power supply voltage during the stable period of the control power supply voltage.

### Fourth Embodiment

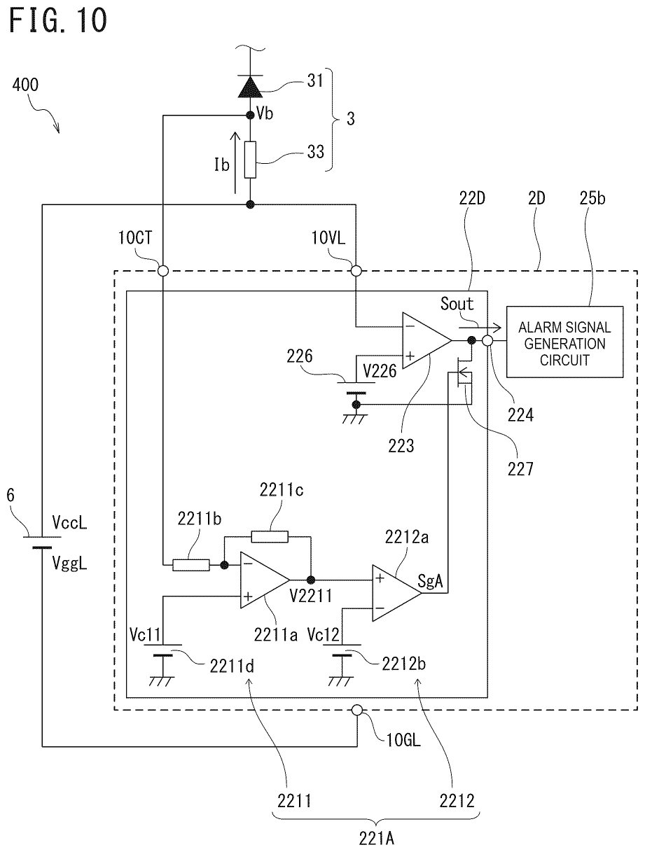

A semiconductor device according to a fourth embodiment of the present disclosure will be described by using FIG. 10. The semiconductor device according to the present embodiment is characterized in that the function of control voltage reduction protection is suspended during the initial charging period. Of the components of the semiconductor device according to the present embodiment, a component having a similar action or function to that of the semiconductor device 100 according to the first embodiment is indicated by an identical sign and is not described.

### 4-1. Entire Structure of Semiconductor Device:

A semiconductor device 400 according to the present embodiment has substantially the same entire structure as the semiconductor device 100 according to the first embodiment, and thus the entire structure is not described.

### 4-2. Structure of Control IC Included in Semiconductor Device:

A control IC for the upper arm (an example of the first control circuit) included in the semiconductor device 400 according to the present embodiment has substantially the same structure as the control IC 1 for the upper arm in the first embodiment and is not described.

A control IC 2D for the lower arm (an example of the second control circuit) included in the semiconductor device according to the present embodiment has substantially the same structure as the control IC 2A for the lower arm in the first embodiment except the structure of a voltage reduction detection circuit. Hence, the entire structure of the control IC 2D for the lower arm included in the semiconductor device 400 according to the present embodiment is not described.

### 4-3. Structure of Voltage Reduction Detection Circuit Included in Semiconductor Device:

A control voltage detection circuit (an example of the voltage reduction detection circuit) 22D included in the control IC 2D of the semiconductor device 400 according to the present embodiment will be described by using FIG. 10. FIG. 10 is a circuit block diagram schematically illustrating an example structure of the control voltage detection circuit 22D in the present embodiment.

As illustrated in FIG. 10, the control voltage detection circuit 22D has a period detection circuit 221A, a comparator 223, a signal output terminal 224, a voltage generation circuit 226, and a transistor 227.

The voltage generation circuit 226, for example, is constituted by a DC power supply. The positive electrode side of the voltage generation circuit 226 is connected to the non-inverting input terminal (+) of the comparator 223. The negative electrode side of the voltage generation circuit 226 is connected to a reference potential terminal (for example, a ground terminal) of the semiconductor device 400 according to the present embodiment. Accordingly, the negative electrode side of the voltage generation circuit 226 has the same potential as the reference potential terminal 10GL. The voltage generation circuit 226 is configured to output a determination voltage V226 of the same voltage level as the determination voltage V222 output from the voltage conversion circuit 222 in the first embodiment after the end of the initial charging period. Accordingly, in the present embodiment, the determination voltage V226 input from the voltage generation circuit 226 to the comparator 223 is constant both during the initial charging period and after the end of the initial charging period (at any time).

The signal output terminal 224 is a terminal that outputs an output signal Sout indicating, as a voltage level, whether the control power supply voltage VccL decreases.

The transistor 227 (an example of the stationary circuit) is a circuit that fixes a voltage level of the signal output terminal 224 to a voltage level at which the output signal Sout does not indicate a reduction in the control power supply voltage VccL until the end of the initial charging period is detected by the period detection circuit 221A. The transistor 227, for example, is constituted by an N-type field-effect transistor. The drain of the transistor 227 is connected to the output terminal of the comparator 223 and to the signal output terminal 224. The source of the transistor 227 is connected to a reference potential terminal (for example, a ground terminal) of the semiconductor device 400. Accordingly, the source of the transistor 227 has the same potential as the negative electrode side of the voltage generation circuit 226 and the reference potential terminal 10GL.

The gate of the transistor 227 is connected to the output terminal of the period detection circuit 221A. Specifically, the gate of the transistor 227 is connected to the output terminal of a comparator 2212a included in a comparator circuit 2212 of the period detection circuit 221A. Accordingly, to the gate of the transistor 227, a suggestion signal SgA output from the period detection circuit 221A is input. As described in the first embodiment, the voltage level of the suggestion signal SgA is a high level during the initial charging period and is a low level during the control voltage stable period after the end of the initial charging period.

Hence, the transistor 227 is in the on state during the initial charging period, and thus the potential of the signal output terminal 224 is a low level (for example, a ground potential) during the initial charging period. Accordingly, the control voltage detection circuit 22D outputs the output signal Sout of a low voltage level to the alarm signal generation circuit 25b regardless of whether the control power supply voltage VccL is higher or lower than the determination voltage V226 during the initial charging period. The output signal Sout of a low voltage level is a voltage that is output to the alarm signal generation circuit 25b when the control power supply voltage VccL does not decrease. Hence, the control voltage detection circuit 22D suspends the function of control voltage reduction protection during the initial charging period.

In contrast, during the control voltage stable period after the end of the initial charging period, the transistor 227 is in the off state. As a result, the signal output terminal 224 is electrically disconnected from the reference potential terminal of the semiconductor device 400. Accordingly, during the control voltage stable period after the end of the initial charging period, the output signal Sout of a voltage level corresponding to the comparison result of the comparator 223 is output from the signal output terminal 224 to the alarm signal generation circuit 25b.

### 4-4. Operation of Semiconductor Device

In the operation of protecting the control IC from a reduction in the control power supply voltage in bootstrap operation as an example operation of the semiconductor device 400 according to the present embodiment, the suggestion signal SgA output from the period detection circuit 221A is used to suspend the control voltage protection function during the initial charging period or to resume the control voltage protection function after the end of the initial charging period. The method of detecting the end of the initial charging period in the period detection circuit 221A in the present embodiment is substantially the same as in the period detection circuit 221A in the first embodiment. Hence, the operation of the semiconductor device according to the present embodiment is not described.

### 4-5. Effect of Semiconductor Device

In the semiconductor device 400 according to the present embodiment, the function of control voltage reduction protection is suspended during the initial charging period, and thus unintended activation of the reduction protection of control power supply voltage VccL is suppressed during the initial charging period. In addition, the semiconductor device 400 can exert the function of control voltage reduction protection after the end of the initial charging period. Hence, the semiconductor device 400 achieves substantially the same effect as the semiconductor device 100 according to the first embodiment.

As described above, the semiconductor device 400 according to the present embodiment includes the IGBT 41, the IGBT 51 connected in series with the IGBT 41 and provided on a lower potential side than the IGBT 41, the control IC 1 configured to control drive operation of the IGBT 41, the control IC 2D configured to control drive operation of the IGBT 51 and protection operation of the IGBT 41 and the IGBT 51, and the bootstrap circuit 3 configured to generate a control power supply voltage VccU supplied to the control IC 1 by bootstrap operation using a control power supply voltage VccL supplied to the control IC 2D. The control IC 2D has the control voltage detection circuit 22D configured to detect a reduction in the control power supply voltage VccL, and the control voltage detection circuit 22D has the period detection circuit 221A configured to detect an initial charging period in which the bootstrap circuit 3 is initially charged by the bootstrap operation.

Accordingly, the semiconductor device 400 according to the present embodiment can suppress unintended activation of the reduction protection of control power supply voltage during the initial charging period and enables the reduction protection of control power supply voltage during the stable period of the control power supply voltage.

The control voltage detection circuit 22D included in the semiconductor device 400 includes a signal output terminal 224 that outputs an output signal indicating, as a voltage level, whether the control power supply voltage VccL decreases and includes a transistor 227 that fixes a voltage level of the signal output terminal 224 to a voltage level at which the output signal does not indicate a reduction in the control power supply voltage VccL until the end of the initial charging period is detected by the period detection circuit 221A.

Accordingly, the semiconductor device 400 can suspend the function of control voltage reduction protection during the initial charging period and thus can suppress unintended activation of the reduction protection of control power supply voltage VccL during the initial charging period.

### Fifth Embodiment

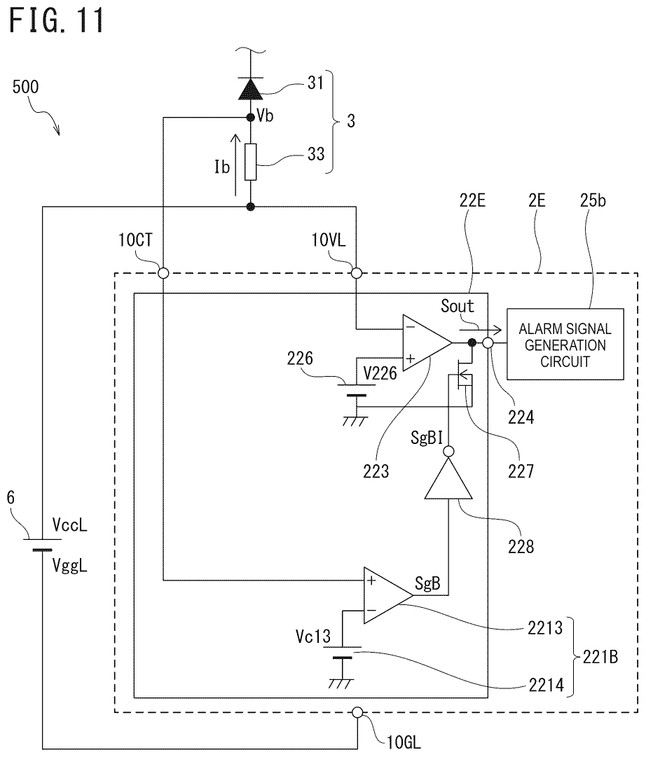

A semiconductor device according to a fifth embodiment of the present disclosure will be described by using FIG. 11. The semiconductor device according to the present embodiment is characterized in that the function of control voltage reduction protection is suspended during the initial charging period. Of the components of the semiconductor device according to the present embodiment, a component having a similar action or function to that of at least one of the semiconductor device according to the second embodiment and the semiconductor device according to the fourth embodiment is indicated by an identical sign and is not described.

### 5-1. Entire Structure of Semiconductor Device

A semiconductor device 500 according to the present embodiment has substantially the same entire structure as the semiconductor device 200 according to the second embodiment, and thus the entire structure is not described.

### 5-2. Structure of Control IC Included in Semiconductor Device

A control IC for the upper arm (an example of the first control circuit) included in the semiconductor device according to the present embodiment has substantially the same structure as the control IC for the upper arm in the second embodiment and is not described.

A control IC 2E for the lower arm (an example of the second control circuit) included in the semiconductor device 500 according to the present embodiment has substantially the same structure as the control IC 2B for the lower arm in the second embodiment except the structure of a voltage reduction detection circuit. Hence, the entire structure of the control IC 2E for the lower arm included in the semiconductor device according to the present embodiment is not described.

### 5-3. Structure of Voltage Reduction Detection Circuit Included in Semiconductor Device

A control voltage detection circuit (an example of the voltage reduction detection circuit) 22E included in the control IC 2E of the semiconductor device 500 according to the present embodiment will be described by using FIG. 11. FIG. 11 is a circuit block diagram schematically illustrating an example structure of the control voltage detection circuit 22E included in the semiconductor device 500 according to the present embodiment.

As illustrated in FIG. 11, the control voltage detection circuit 22E has a period detection circuit 221B, a comparator 223, a signal output terminal 224, a voltage generation circuit 226, a transistor 227, and a NOT gate 228.

The input terminal of the NOT gate 228 is connected to the output terminal of the period detection circuit 221B. The output terminal of the NOT gate 228 is connected to the gate of the transistor 227. Accordingly, to the gate of the transistor 227, an inverted signal SgBI that is prepared by inverting a voltage level of the suggestion signal SgB output from the period detection circuit 221B is input. As described in the second embodiment, the voltage level of the suggestion signal SgB is a low level during the initial charging period and is a high level during the control voltage stable period after the end of the initial charging period. Hence, the voltage level of the inverted signal SgBI is a high level during the initial charging period and is a low level during the control voltage stable period after the end of the initial charging period.

Accordingly, the transistor 227 in the embodiment operates in a similar manner to the transistor 227 in the fourth embodiment. Hence, the control voltage detection circuit 22E suspends the function of control voltage reduction protection during the initial charging period. In contrast, after the end of the initial charging period (i.e., during the control voltage stable period), the output signal Sout of a voltage level corresponding to the comparison result of the comparator 223 is output from the signal output terminal 224 to the alarm signal generation circuit 25b.

### 5-4. Operation of Semiconductor Device

In the operation of protecting the control IC from a reduction in the control power supply voltage in bootstrap operation as an example operation of the semiconductor device 500 according to the present embodiment, the suggestion signal SgB output from the period detection circuit 221B is used to suspend the control voltage protection function during the initial charging period and to resume the control voltage protection function after the end of the initial charging period. The method of detecting the end of the initial charging period in the period detection circuit 221B in the present embodiment is substantially the same as the period detection circuit 221B in the second embodiment. Hence, the operation of the semiconductor device 500 according to the present embodiment is not described.

### 5-5. Effect of Semiconductor Device

In the semiconductor device 500 according to the present embodiment, the function of control voltage reduction protection is suspended during the initial charging period, and thus unintended activation of the reduction protection of control power supply voltage VccL is suppressed during the initial charging period. In addition, the semiconductor device 500 can exert the function of control voltage reduction protection after the end of the initial charging period. Hence, the semiconductor device 500 achieves substantially the same effect as the semiconductor device 400 according to the fourth embodiment.

As described above, the semiconductor device 500 according to the present embodiment includes the IGBT 41, the IGBT 51 connected in series with the IGBT 41 and provided on a lower potential side than the IGBT 41, the control IC 1 configured to control drive operation of the IGBT 41, the control IC 2E configured to control drive operation of the IGBT 51 and protection operation of the IGBT 41 and the IGBT 51, and the bootstrap circuit 3 configured to generate a control power supply voltage VccU supplied to the control IC 1 by bootstrap operation using a control power supply voltage VccL supplied to the control IC 2E. The control IC 2E has the control voltage detection circuit 22E configured to detect a reduction in the control power supply voltage VccL, and the control voltage detection circuit 22E has the period detection circuit 221B configured to detect an initial charging period in which the bootstrap circuit 3 is initially charged by the bootstrap operation.

Accordingly, the semiconductor device 500 according to the present embodiment can suppress unintended activation of the reduction protection of control power supply voltage during the initial charging period and enables the reduction protection of control power supply voltage during the stable period of the control power supply voltage.

The control voltage detection circuit 22E included in the semiconductor device 500 has a signal output terminal 224 that outputs an output signal indicating, as a voltage level, whether the control power supply voltage VccL decreases and has a transistor 227 that fixes a voltage level of the signal output terminal 224 to a voltage level at which the output signal does not indicate a reduction in the control power supply voltage VccL until the end of the initial charging period is detected by the period detection circuit 221B.

Accordingly, the semiconductor device 500 can suspend the function of control voltage reduction protection during the initial charging period and thus can suppress unintended activation of the reduction protection of control power supply voltage VccL during the initial charging period.

The present disclosure is not limited to the above embodiments and may be modified in various ways.

In the first embodiment to the fifth embodiment, the voltage on the anode side of the bootstrap diode 31 is used as the charging voltage Vb, but the present disclosure is not limited to this structure. For example, even if the charging voltage Vb is a voltage on the cathode side of the bootstrap diode 31, substantially the same effect as the semiconductor devices in the first embodiment to the fifth embodiment is achieved.

In the first embodiment to the fifth embodiment, the charging voltage Vb on the anode side of the bootstrap diode 31 is used to detect the end of the initial charging period, but the present disclosure is not limited to this structure. For example, the voltage between the two electrodes of the bootstrap capacitor 32 (i.e., the control power supply voltage VccU for the upper arm) may be used to detect the end of the initial charging period. Even in this case, substantially the same effect as the semiconductor devices in the first embodiment to the fifth embodiment is achieved.

In the fourth embodiment and the fifth embodiment, by setting the potential of the signal output terminal 224 to the same potential as, for example, the reference potential terminal of the semiconductor device, the function of control voltage reduction protection is suspended during the initial charging period, but the present disclosure is not limited to this structure. For example, in the voltage conversion circuit 222 in the first embodiment to the third embodiment, the determination voltage V222 may be set at 0 V during the initial charging period. Accordingly, the control power supply voltage VccL does not decrease below the determination voltage V222 during the initial charging period, and thus the period detection circuits 221A, 221B, 221C become in a state similar to the state in which the function of control voltage reduction protection is suspended.

### REFERENCE SIGNS LIST

1, 2A, 2B, 2C, 2D, 2E: control IC
3: bootstrap circuit
4, 5: drive element
6, 226, 232, 243, 2211d, 2212b, 2214: voltage generation circuit
10CS: start signal input terminal
10CT: charging voltage input terminal
10GL, 10GU: reference potential terminal
10M: intermediate terminal
10N: negative electrode side voltage input terminal
10P: positive electrode side voltage input terminal
10SL, 10SU: control signal input terminal
10VFO: alarm signal output terminal
10VL, 10VU: control power supply voltage input terminal (power supply input terminal)
21: gate drive circuit
22A, 22AM, 22B, 22BM, 22C, 22D, 22E: control voltage detection circuit
23: temperature detection circuit
24: current detection circuit
25a: OR gate
25b: alarm signal generation circuit
25c, 227: transistor
25d, 233: constant current source
25e, 241: resistance element
31: bootstrap diode
32: bootstrap capacitor
33: limiting resistor
41, 51: IGBT
42, 52: free wheeling diode
53: temperature sensor
54: current sensor
100, 100M, 200, 200M, 300, 400, 500: semiconductor device
211: on/off control circuit
221A, 221B, 221C: period detection circuit
222: voltage conversion circuit
223, 231, 242, 2212a, 2213 comparator
224: signal output terminal
225, 2215: delay circuit
228: NOT gate
2211: differential amplifier circuit
2211a: amplifier
2211b: input resistor
2211c: feedback resistor
2212: comparator circuit
Ib: charging current
Pic: initial charging period
Pso: control voltage stable period
Scs: charging start signal
SgA, SgB, SgC: suggestion signal
SgBI: inverted signal
SinL, SinU: input signal
Sout: output signal
V222, V226: determination voltage
Vdtm: determination voltage
V2211: output voltage
Vb: charging voltage
Vc11, Vc12, Vc13: comparison voltage
VccL, VccU: control power supply voltage
VggL, VggU: reference potential
Vpic, Vpso: voltage level
Vtg: target level
α: charging path

1. A semiconductor device comprising:
a first switching element;
a second switching element connected in series with the first switching element and provided on a lower potential side than the first switching element;
a first control circuit configured to control drive operation of the first switching element;
a second control circuit configured to control drive operation of the second switching element, protection operation of the first switching element, and protection operation of the second switching element;
a bootstrap circuit configured to generate a first control power supply voltage supplied to the first control circuit by bootstrap operation using a second control power supply voltage supplied to the second control circuit, wherein
the second control circuit has a voltage reduction detection circuit configured to detect a reduction in the second control power supply voltage, and
the voltage reduction detection circuit has a period detection circuit configured to detect an initial charging period in which the bootstrap circuit is initially charged by the bootstrap operation.

2. The semiconductor device according to claim 1, wherein the voltage reduction detection circuit has a voltage conversion circuit configured to increase a determination voltage for determining a reduction in the second control power supply voltage, after an end of the initial charging period is detected by the period detection circuit rather than before the end of the initial charging period is detected.

3. The semiconductor device according to claim 2, wherein the voltage conversion circuit sets the determination voltage to 0 V during the initial charging period.

4. The semiconductor device according to claim 1, wherein the period detection circuit detects the initial charging period on the basis of a difference between a charging voltage based on a charging current flowing through the bootstrap circuit during the bootstrap operation and a comparison voltage having a voltage level substantially equal to the second control power supply voltage.

5. The semiconductor device according to claim 1, wherein the period detection circuit detects the initial charging period on the basis of a charging voltage based on a charging current flowing through the bootstrap circuit during the bootstrap operation.

6. The semiconductor device according to claim 2, wherein the voltage reduction detection circuit has a delay circuit configured to delay a suggestion signal by a predetermined period and to output a delayed suggestion signal to the voltage conversion circuit, wherein the suggestion signal is input from the period detection circuit and indicates detection of the end of the initial charging period.

7. The semiconductor device according to claim 2, wherein the period detection circuit has a delay circuit configured to delay a charging start signal by a predetermined period and to output a delayed charging start signal as a suggestion signal to the voltage conversion circuit, wherein the charging start signal indicates a start of the initial charging to the bootstrap circuit, and the suggestion signal indicates detection of the end of the initial charging period.

8. The semiconductor device according to claim 1, wherein the voltage reduction detection circuit has
an output terminal configured to output an output signal indicating, as a voltage level, whether the second control power supply voltage decreases, and
a stationary circuit configured to fix a voltage level of the output terminal to a voltage level at which the output signal does not indicate a reduction in the second control power supply voltage until the end of the initial charging period is detected by the period detection circuit.

9. The semiconductor device according to claim 2, wherein the period detection circuit detects the initial charging period on the basis of a difference between a charging voltage based on a charging current flowing through the bootstrap circuit during the bootstrap operation and a comparison voltage having a voltage level substantially equal to the second control power supply voltage.

10. The semiconductor device according to claim 3, wherein the period detection circuit detects the initial charging period on the basis of a difference between a charging voltage based on a charging current flowing through the bootstrap circuit during the bootstrap operation and a comparison voltage having a voltage level substantially equal to the second control power supply voltage.

11. The semiconductor device according to claim 2, wherein the period detection circuit detects the initial charging period on the basis of a charging voltage based on a charging current flowing through the bootstrap circuit during the bootstrap operation.

12. The semiconductor device according to claim 3, wherein the period detection circuit detects the initial charging period on the basis of a charging voltage based on a charging current flowing through the bootstrap circuit during the bootstrap operation.
